(19) United States
(12) Patent Application Publication
(10) Pub. No.: US 2024/0177193 A1
(43) Pub. Date: May 30, 2024

(54) INFORMATION PROCESSING DEVICE

(71) Applicant: TOYOTA JIDOSHA KABUSHIKI KAISHA, Toyota-shi (JP)

(72) Inventors: Kai TANAKA, Kumamoto-shi (JP); Junpei OKAMOTO, Sayama-shi (JP); Makoto KINOSHITA, Tokyo-to (JP)

(73) Assignee: TOYOTA JIDOSHA KABUSHIKI KAISHA, Toyota-shi (JP)

(21) Appl. No.: 18/464,524

(22) Filed: Sep. 11, 2023

(30) Foreign Application Priority Data
Nov. 29, 2022 (JP) 2022-190677

(51) Int. Cl. G06Q 30/0251; G01C 21/36

(52) U.S. Cl. CPC G06Q 30/0261; G01C 21/3697

(57) ABSTRACT

An information processing device including a control unit, wherein the control unit acquires information indicating an action tendency of a user from a terminal device of the user, and when it is determined that the base of the user has been changed based on the information, executes a first change process of changing an advertisement due to a geographical change of the base, and determines whether or not to execute a second change process of changing an advertisement related to a lifestyle of the user according to whether or not the change of the base satisfies a predetermined condition.

### CROSS-REFERENCE TO RELATED APPLICATION

This application claims priority to Japanese Patent Application No. 2022-190677 filed on Nov. 29, 2022, incorporated herein by reference in its entirety.

### BACKGROUND

### 1. Technical Field

The present disclosure relates to an information processing device.

### 2. Description of Related Art

Conventionally, a technique relating to targeted advertising has been known. For example, Japanese Unexamined Patent Application Publication No. 2019-160178 (JP 2019-160178 A) discloses a technique for estimating an action attribute of a user based on position information of the user.

### SUMMARY

When a base such as home or an office of a person is changed due to various circumstances, the lifestyle of the person may also change. At this time, a new demand for goods or services is likely to occur, and the appeal effect of advertisement is likely to be enhanced. However, in the related art, the position information of the user of the terminal device is acquired in real time so as to improve an estimation accuracy of the action of the target. As a result, a data processing load of the entire system and a battery load of the terminal device become high. Therefore, in the related art, it is difficult to easily detect a change of the base of the user, and thus there is room for improvement.

In view of such circumstances, an object of the present disclosure is to improve a technique related to a targeted advertising.

An information processing device according to the present disclosure is an information processing device provided with a control unit.

The control unit acquires information indicating an action tendency of a user from a terminal device of the user, and executes a first change process of changing an advertisement due to a geographical change of a base of the user when a change of the base is determined to be made, and determines whether to execute a second change process of changing an advertisement related to a lifestyle of the user in accordance with whether the change of the base satisfies a predetermined condition, based on the information.

According to an embodiment of the present disclosure, a technique related to a targeted advertising is improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a schematic configuration of a system according to an embodiment of the present disclosure;

FIG. 2 is a block diagram illustrating a schematic configuration of a terminal device;

FIG. 3 is a block diagram illustrating a schematic configuration of an information processing device;

FIG. 4 is a diagram illustrating an example of a user database;

FIG. 5 is a diagram illustrating an example of a base candidate database;

FIG. 6 is a flowchart illustrating an operation of the information processing device.

### DETAILED DESCRIPTION OF EMBODIMENTS

Hereinafter, embodiments of the present disclosure will be described below with reference to the drawings.

### Outline of Embodiment

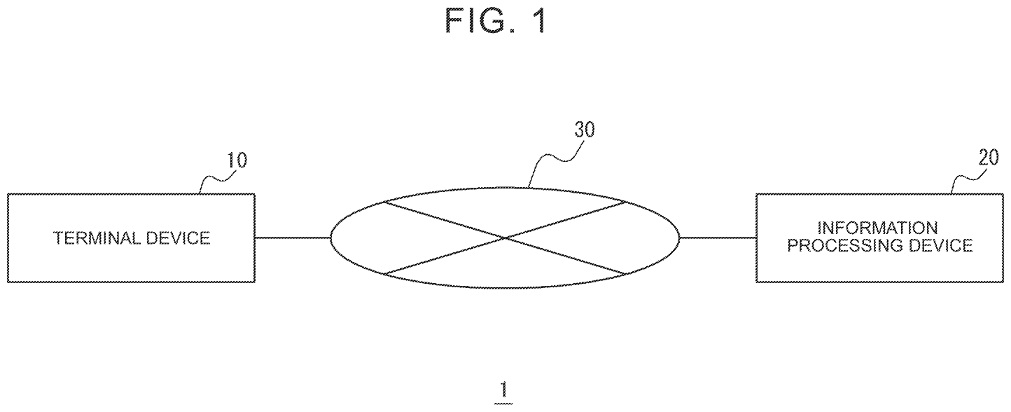

The outline of a system 1 according to an embodiment of the present disclosure will be described with reference to FIG. 1. The system 1 includes a terminal device 10 and an information processing device 20. The terminal device 10 and the information processing device 20 are communicably connected to a network 30 including, for example, the Internet and a mobile communication network.

The terminal device 10 is held by a user. The terminal device 10 is, for example, a mobile phone, a mobile device such as a smartphone or a tablet, a personal computer (PC), or a vehicle-mounted device such as a car navigation device. The number of the terminal devices 10 included in the system 1 may be arbitrarily determined. The user can operate the terminal device 10 to use various web services on the terminal device 10 via the network 30. In addition, the user can operate the terminal device 10 to execute a predetermined function on an arbitrary application program.

In the present embodiment, the application program is an application program (hereinafter, also referred to as “geographic application”) into which geographical information is input. The geographic application includes, but is not limited to, an application program (hereinafter, also referred to as a “route search application”) used for route search. For example, a user may perform a route search from a departure point to a destination and view route search results on a route search application. In the present embodiment, the route search result includes a departure point, a destination, and a departure and arrival time of the passenger vehicle. As will be described later, the information processing device 20 can acquire the route search result from the terminal device 10, and can estimate when and where the user is likely to appear from the departure point, the destination, and the departure and arrival time of the passenger vehicle. The route search result is not limited to these, and may include, for example, information of a neighboring facility such as a line-side store. The user may register an arbitrary point on the route search application, and set any of the registered points (hereinafter, also referred to as “registered points”) as a departure point, a passing point, or a destination at the time of route search. As a result, the user can save the time and effort of inputting the same location every time the route search is performed. Registration points may be, but are not limited to, locations where users frequently use route searches, typically the user's home, school, or workplace. The user may register identification information of each registration point, typically a point name such as “home” or “work.” The user may view the route search results on the route search application. The route search results may include, in addition to a departure point and a destination, a departure point (a station, a stop, a port, or the like) of a passenger vehicle (a railway, a bus, or the like) or a micromobility (an electrically assisted bicycle, or the like) normally used by a user. In the following, these departure and arrival points are collectively referred to as “used stations.” However, the functions executable on the route search application are not limited thereto, and may include any other functions such as, for example, a reservation purchase of a traffic ticket (a passenger ticket of a passenger vehicle, a traveling ticket, etc.). The application program may be installed in the terminal device 10 or may be an application service provider (ASP) service-based application program that is available via a web browser.

The information processing device 20 is, for example, a computer such as a server apparatus. The information processing device 20 can communicate with the terminal device 10 via the network 30.

First, the outline of the present embodiment will be described, and the details will be described later. The information processing device 20 acquires information indicating an action tendency of the user from the terminal device 10 of the user. On the basis of the information, when it is determined that the base of the user has been changed, the information processing device 20 executes a first change process of changing the advertisement due to the geographical change of the base, and determines whether to execute a second change process of changing the advertisement related to the lifestyle of the user according to whether or not the change of the base satisfies a predetermined condition.

As described above, according to the present embodiment, even if the user's position information is acquired in real time and the user's action is not comprehensively grasped as in the prior art, it is possible to detect the change of the user's base based on the information indicating the user's action tendency. When the change of the base of the user is detected, the first change process is executed, and it is determined whether or not the second change process is executed according to whether or not the change of the base satisfies a predetermined condition. For this reason, for example, when a change in the base is detected, the advertisement is changed due to the geographical change of the base, but if the change in the lifestyle is not detected even if the base is changed, the advertisement related to the lifestyle may not be changed. Therefore, the technology related to the targeting advertisement is improved in that it is easy to present an advertisement tailored to the lifestyle of the user while easily detecting a change in the base of the user and specifying a timing at which the advertising appeal effect is high.

Next, each configuration of the system 1 will be described in detail.

### Configuration of Terminal Device

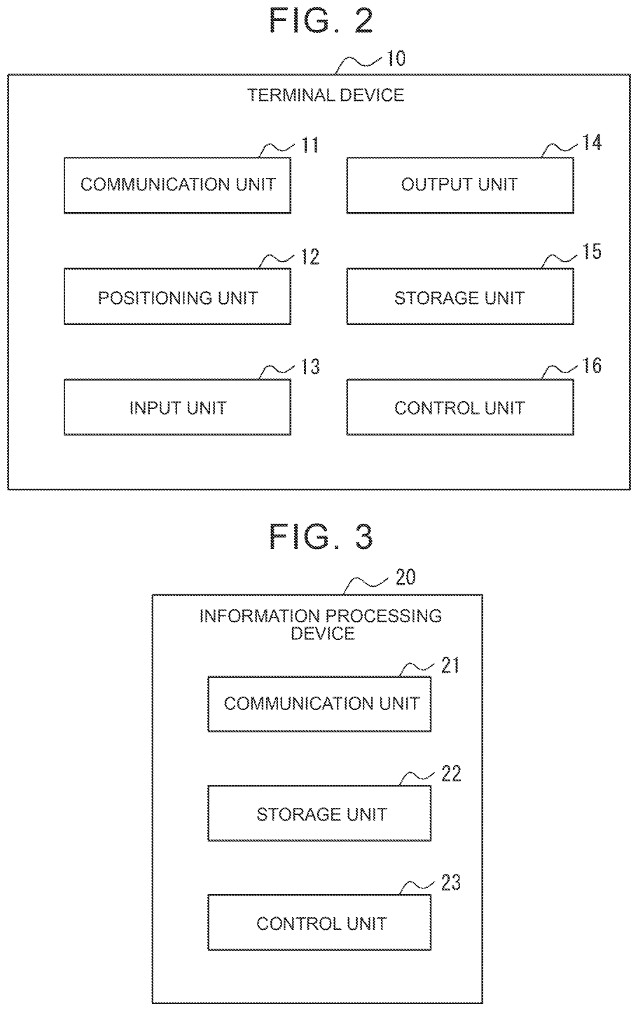

As illustrated in FIG. 2, the terminal device 10 includes a communication unit 11, a positioning unit 12, an input unit 13, an output unit 14, a storage unit 15, and a control unit 16.

The communication unit 11 includes one or more communication interfaces connected to the network 30. The communication interfaces correspond to mobile communication standards such as 4th Generation (4G) or 5th Generation (5G), but are not limited thereto. The terminal device 10 communicates with the information processing device 20 via the communication unit 11 and the network 30. In the present embodiment, the terminal device 10 transmits information (application information, usage history, and the like) stored in a user database or a base candidate database, which will be described later, to the information processing device 20.

The positioning unit 12 includes one or more devices that acquire position information of the terminal device 10. Specifically, the positioning unit 12 includes, for example, a receiver corresponding to Global Positioning System (GPS), but is not limited thereto, and may include a receiver corresponding to any satellite-based positioning system.

The input unit 13 includes at least one input interface. The input interface is, for example, a physical key, a capacitive key, a pointing device, or a touch screen integrally provided with a display. The input unit 13 receives an operation of inputting data used for the operation of the terminal device 10. Instead of being provided in the terminal device 10, the input unit 13 may be connected to the terminal device 10 as an external input device. As the connecting interface, for example, an interface corresponding to a standard such as Universal Serial Bus (USB), High-Definition Multimedia Interface (HDMI (registered trademark)), or Bluetooth (registered trademark) can be used.

The output unit 14 may include one or more output devices that output information and notify the user. The output device is, for example, but not limited to, a display for outputting information in an image or a video, a speaker for outputting information in a sound, or the like. Displays are, for example, liquid crystal display (LCD) or organic electro luminescence (EL) displays. The output unit 14 may include an interface for connecting an external output device. 30

The storage unit 15 includes one or more memories. The memories are, for example, a semiconductor memory, a magnetic memory, or an optical memory, but are not limited to these memories. Each memory included in the storage unit 15 may function as, for example, a main storage device, an auxiliary storage device, or a eache memory. The storage unit 15 stores any information used for the operation of the terminal device 10. For example, the storage unit 15 may store a system program, an application program, embedded software, and the like. The information stored in the storage unit 15 may be updatable with information received from the network 30 via the communication unit 11, for example. In the present embodiment, the storage unit 15 may store any geographic application. Further, the storage unit 15 may store information stored in a user database or a base candidate database, which will be described later.

The control unit 16 includes one or more processors, one or more programmable circuits, one or more dedicated circuits, or a combination of these. The processor may be, but is not limited to, a general-purpose processor such as, for example, Central Processing Unit (CPU) or Graphics Processing Unit (GPS), or a special-purpose processor specialized for a particular process. The programmable circuitry is, for example, but not limited to, Field-Programmable Gate Array (FPGA). The dedicated circuitry is, for example, but not limited to, Application Specific Integrated Circuit (ASIC). The control unit 16 controls the operation of the terminal device 10 as a whole.

### Configuration of Information Processing Device

As shown in FIG. 3, the information processing device 20 includes a communication unit 21, a storage unit 22, and a control unit 23.

The communication unit 21 includes one or more communication interfaces connected to the network 30. The communication interfaces correspond to, for example, a mobile communication standard, a wired Local Area Network (LAN) standard, or a radio LAN standard, but are not limited thereto, and may correspond to any communication standard. The information processing device 20 communicates with the terminal device 10 via the communication unit 21 and the network 30. In the present embodiment, the information processing device 20 receives information stored in a user database or a base candidate database, which will be described later, from the terminal device 10 of the user.

The storage unit 22 includes one or more memories. Each memory included in the storage unit 22 may function as, for example, a main storage device, an auxiliary storage device, or a eache memory. The storage unit 22 stores any information used for the operation of the information processing device 20. For example, the storage unit 22 may store a system program, an application program, a database, and the like. The information stored in the storage unit 22 may be updatable with information received from the network via the communication unit 21, for example.

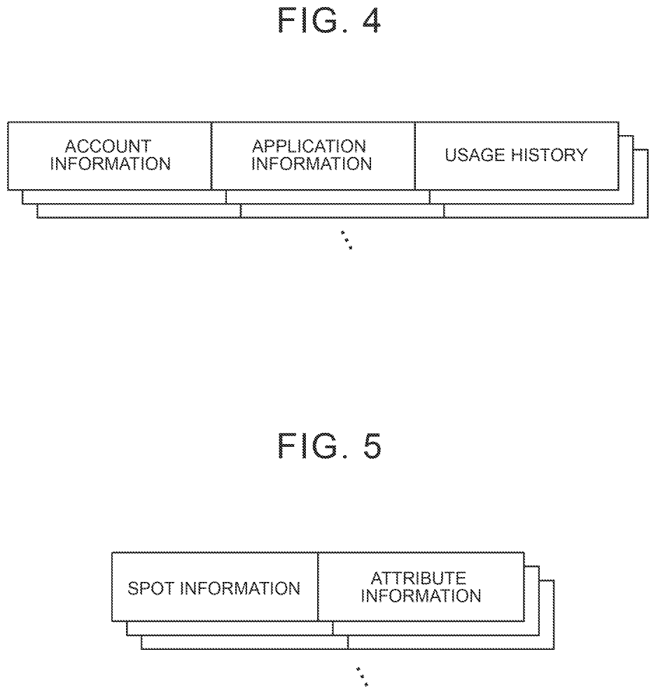

In the present embodiment, the storage unit 22 stores a user database as illustrated in FIG. 4 and a base candidate database as illustrated in FIG. 5.

As illustrated in FIG. 4, the user database includes user data having “account information”. “application information”, and “usage history” for each user of the terminal device 10.

The “account information” includes any information related to the user of the terminal device 10. For example, the account information may include, but is not limited to, information such as a login ID and password for logging into various application programs or web services, user ID, username, user age and gender, etc. The term “ID” is an abbreviation for identifier.

The “application information” includes any information identifying an application program used in the terminal device 10 of the user. In this embodiment, the application program includes any geographic application.

The “usage history” includes information such as a start time, a use time, registration information, and an execution result of each application program identified by the application information. In the present embodiment, the usage history includes information that can serve as a clue for determining whether or not the base of the user of the terminal device 10 has been changed. Details of the user's base and the like will be described later.

As illustrated in FIG. 5, the base candidate database includes data of site candidates having “spot information” and “attribute information”. The “base candidate” is an arbitrary place that can be a candidate for the base of the present embodiment. In the present embodiment, such a place is also referred to as a spot.

The “spot information” includes any information indicating each spot registered by the user of the terminal device 10 on the geographic application among the application programs identified by the application information of the user database. The geographic application may be distinguished from an application program into which the geographical information is not input by using data such as a flag. The spot information may include, for example, a location (such as two-dimensional coordinate data including longitude and latitude) of each spot, such as a home, a school, a work, or a use station, which the user has registered on the route search application. In this case, the spot information may include identification information of each spot in association with the location of each spot. The identification information is a point name such as “home” or “workplace” which is typically arbitrarily set by the user. Each spot indicated by the spot information may be a candidate of a base of the present embodiment, as will be described later.

The “attribute information” includes any information indicating a characteristic of each spot indicated by the spot information. For example, the attribute information may include information indicating a household ratio for each age group of each region including a plurality of spots (hereinafter, also referred to as “household ratio information”). The attribute information may include a plurality of area types set based on the household ratio information. The “area type” is information indicating the characteristics of each region including a plurality of spots, and specifically includes information obtained by classifying the characteristics of the inhabitants of each region by an arbitrary method. For example, the area type may be set based on information obtained by analyzing a feature of a purchaser based on purchasing information of a product or a service (hereinafter, also referred to as “product, etc.”), classifying a type of a purchaser of a unit of the product, etc., and classifying a feature of a resident of each region based on a purchasing area of the product, etc. As the area type, any type can be set. For example, the first area type, the second area type, and the third area type may be set as the area type. The “first area type” refers to an area where a large number of single-person households live (typically a downtown area). The “second area type” indicates an area where many family houscholds live (typically, a residential area in an environment that is easy to raise children). The “third area type” indicates an office district (such as an area where office buildings are concentrated and located). Further, various types of area types may be set.

The control unit 23 includes one or more processors, one or more programmable circuits, one or more dedicated circuits, or a combination of these. The control unit 23 controls the operation of the information processing device 20 as a whole.

### Operation Flow of Information Processing Device

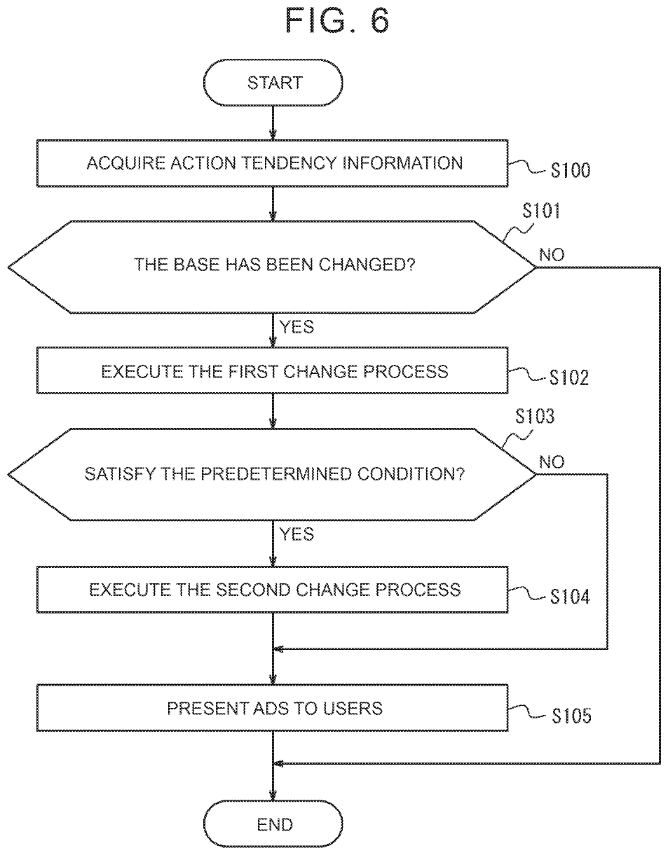

An operation of the information processing device 20 according to the present embodiment will be described with reference to FIG. 6. The operation of FIG. 6 corresponds to the method according to the present embodiment. This operation is repeatedly executed at a predetermined cycle. The predetermined period may be arbitrarily determined in consideration of the data processing load of the entire system 1 and the battery load of the terminal device 10. In the present embodiment, this operation is executed once a day at a predetermined time. The predetermined time may be arbitrarily set. For example, by setting the predetermined time to 0:00 a.m., the content of the advertisement to be presented to the user on the day may be adjusted based on the action tendency information on the previous day. The predetermined period is not limited to this, and may be set to, for example, several times per day.

S100: The control unit 23 of the information processing device 20 acquires information indicating the action tendency of the user (hereinafter, also referred to as “action tendency information”) from the terminal device 10 of the user.

Specifically, the control unit 23 receives the action tendency information from the communication unit 11 of the terminal device 10 via the network 30 and the communication unit 21 in association with the account information of the user of the terminal device 10. The control unit 23 can acquire the action tendency information by receiving the action tendency information from the terminal device 10 of the user every time the operation of FIG. 6 is executed.

The action tendency information is arbitrary information indicating an action tendency of the user of the terminal device 10. In the present embodiment, the action tendency information may include position information of the terminal device 10, a usage history of an application program (geographic application) into which the geographical information is input, or both. On the geographic application, since the geographical information is inputted by the user, the usage history of the geographic application makes it easier to identify the base of the user, which will be described later in S101. For example, the geographic application may be a route search application. In the case of the route search application, the usage history may include registration information of the use station, route search results, or both. These pieces of information may include not only current information but also past histories. It is desirable to acquire newly accumulated or updated information from the point of time of previous acquisition. The usage history may include, but is not limited to, any other information, for example, registration information of a user's home, school, or workplace, or payment information. The settlement information may include information such as a settlement means (type of settlement means, etc.), a use store, or a purchased product (e.g., purchase of a traffic ticket) used by the user of the terminal device 10. The usage history includes information that can serve as a clue for determining whether or not the base of the user has been changed in a S101 described later.

As described above, in the present embodiment, the frequency of acquisition of the action tendency information is once a day. Therefore, the data processing load of the entire system 1 and the battery load of the terminal device 10 can be greatly reduced as compared with, for example, a case where the position information of the user of the terminal device 10 is acquired in real time (so-called continuous monitoring) as in the related art. The same applies to the case where the predetermined cycle described above is several times per day. As the action tendency information, the position information of the terminal device 10 of the user may be acquired in addition to the usage history of the geographic application. The reason will be described in the second example below.

S101: The control unit 23 determines whether or not the base of the user has been changed based on the action tendency data acquired by S100. When the control unit 23 determines that the base of the user has been changed (S101—Yes), the processing proceeds to S102. On the other hand, when the control unit 23 determines that the base of the user has not been changed (S101—No), the processing ends.

The “base of the user” is a place where the user of the terminal device 10 has a higher frequency of appearance than other places. “The base of the user has been changed” means that the base where the frequency of appearance of the user is high has been changed.

The control unit 23 extracts a place with a high appearance frequency of the user of the terminal device 10 on the basis of the action tendency information, and identifies the extracted place as a base of the user. Specifically, the control unit 23 compares the action tendency information acquired last time (for example, at 0:00 a.m. on the previous day) with the action tendency information acquired this time (for example, at 0:00 a.m. on the current day). When any one of the bases indicated by the action tendency information acquired each time is different, the control unit 23 determines that the base of the user has been changed. In the present embodiment, the control unit 23 specifies the base indicated by the previously acquired action tendency information as the “base before change”, and specifies the base indicated by the currently acquired action tendency information as the “base after change”.

An arbitrary method can be adopted for extracting a place where the frequency of occurrence of the user is high, and the first to third examples are shown below as specific examples.

The first example is a case where a function (hereinafter, also referred to as a “spot registration function”) that allows a user to register an arbitrary spot corresponding to the base of the present embodiment is provided in the route search application, and the user updates the registration information. In this case, the control unit 23 can extract the spot registered by the user as a place where the user has a high appearance frequency by referring to the usage history of the route search application. Typically, the user also registers the identification information of each spot, for example, the location names of “home”, “work”, and “use station”. In this case, the control unit 23 may estimate each spot registered with a point name as a spot having a high actual appearance frequency of the user, and identify the spot as a base. In this example, since each spot registered with a point name is updated by the user, the spot coincides with a spot having a high actual appearance frequency of the user. Therefore, in the present example, the necessity of acquiring the position information is lower than in the second example described later.

In the second example, a spot registration function is provided in the route search application, but the user does not update registration information such as “home” or “work”. As in the first example, the control unit 23 can extract the spot registered by the user as a place where the user has a high appearance frequency by referring to the usage history of the route search application. However, in the present example, since the spot registered with the point name is not updated by the user unlike the first example, there is a possibility that the spot does not coincide with a place where the actual appearance frequency of the user is high. Therefore, in preparation for such a case, it is desirable that the action tendency information also includes the position information of the terminal device 10 of the user. By acquiring the position information as the action tendency information, even in a case where the registration information on the geographic application is not updated as in the present example, or in a case where it is difficult to identify the user's base from the action tendency information as in the third example described later, it is possible to identify or detect a change in the base of the user's execution. That is, it is possible to identify a spot with a high appearance frequency of the user, regardless of the registration information on the geographic application. In this case, for example, the control unit 23 may analyze the position information indicated by the action tendency information accumulated in the predetermined period to identify a spot having a high actual appearance frequency of the user, and identify the spot as a base. In the present embodiment, since the frequency of acquisition of the action tendency information is low, there is no possibility that the data processing load of the entire system 1 and the battery load of the terminal device 10 increase significantly even if the position information of the terminal device 10 is acquired.

The third example is a case where the spot registration function is not provided in the route search application. In this case, the control unit 23 may refer to the route search result indicated by the usage history, and select 2 to 3 locations from a point having a large number of cumulative times set as a departure point or a destination at the time of route search within a predetermined period. Alternatively, the control unit 23 may specify a spot having a cumulative number of times equal to or greater than a predetermined number of times. The control unit 23 may extract the spot selected or specified in this way as a place where the frequency of appearance of the user is high, and identify the spot as a base.

The control unit 23 may compare the bases (longitude and latitude, and the like) indicated by the action tendency information of the respective times identified in this way, and determine that the bases of the user have been changed when there is a base that does not match. The bases do not necessarily have to exactly match, but may set an acceptable predetermined error range. In the case of the second example described above, the control unit 23 may determine that the base of the user has been changed in a case where there is a non-matching base by comparing the bases with the bases with the spots having a high appearance frequency of the user, which are identified by analyzing the position information included in the action tendency information.

S102: When the control unit 23 determines that the base of the user has been changed (S101—Yes), the control unit 23 executes the first change process of changing the advertising due to the geographical change of the basc.

Specifically, the control unit 23 can execute the first change processing by determining, as an advertisement to be presented to the user, an advertisement by an advertiser in the vicinity of the changed base instead of an advertisement by a person who provides a product or the like in the vicinity of the base before the change (hereinafter, also referred to as an “advertiser”). As a result, it is possible to distribute an advertisement targeting a user with a high probability of coming to the store to an advertiser in the vicinity of the changed base.

Although the base of the user may be changed in various ways, a fourth example and a fifth example will be described below as specific examples.

The fourth example is a case where the workplace, which is the commuting destination of the user, is changed due to a job change during a period from the time of acquisition of the previous action tendency information to the time of acquisition of the current action tendency information (hereinafter, also referred to as an “intermediate period”). In this example, the registration information of “work”, “use station”, or both on the route search application may be changed by the user. In this case, the control unit 23 may determine, as an advertisement to be presented to the user, the advertisement by the advertiser in the vicinity of the changed “work” or “use station” instead of the advertisement by the advertiser in the vicinity of the changed “work” or “use station”.

The fifth example is a case where the home, which is a living base of the user, is changed by moving during the intermediate period. In this example, the registration information of “home”, “station of use”, or both may be changed by the user on the route search application. In this case, the control unit 23 may determine, as an advertisement to be presented to the user, the advertisement by the advertiser in the vicinity of the changed “home” or “use station” instead of the advertisement by the advertiser in the vicinity of the changed “home” or “use station”. Further, in the present example, since the “home” of the user who is the living base of the user is changed, unlike the fourth example, there is a possibility that not only the geographical change of the base of the user but also the change of the lifestyle of the user occurs. Therefore, in addition to the adjustment of the advertisement content in accordance with the geographical change of the base (this step), it is desirable to also perform the adjustment of the advertisement content in accordance with the presence or absence of the change in the lifestyle. This is because it is easy to present an advertisement that matches the lifestyle of the user. The determination of the lifestyle change will be described later in S103.

S103: The control unit 23 determines whether or not the change of the base satisfies a predetermined condition. When the control unit 23 determines that the predetermined condition is satisfied (S103—Yes), the control unit 23 estimates that the lifestyle of the user has changed, and determines to execute a second change process to be described later. Processing proceeds to S104. On the other hand, when the control unit 23 determines that the predetermined condition is not satisfied (S103—No), the control unit 23 estimates that the rice style of the user has not changed, and determines not to execute the second change process described later. Processing proceeds to S105.

The predetermined condition may be arbitrarily determined. For example, the predetermined condition may be that the base where the change is detected by S101 is the home of the user, and the area type indicating the property of the area of the home before and after the change has changed (hereinafter, also referred to as “first condition”). Since the home is a living base of the user, when the home is changed, there is a high possibility that the lifestyle of the user also changes as compared to when the other base is changed. The likelihood is particularly high if the move is made on the basis of childbirth. For example, in the fourth example described above, when the user moves from the city A (shopping district) to the city B (a residential district that is popular among family households), there is a high possibility that the transfer was made on the occasion of childbirth. Therefore, when the first condition is satisfied, the control unit 23 may estimate that the user's rice style has changed, and may decide to execute a second change process to be described later.

Specifically, when the user's home is included in the base where the change is detected by S101, the control unit 23 may identify the area type of the home before and after the change by referring to the spot information of the base candidate database. If the area type does not change before and after the change of the base, it can be said that the characteristics of the inhabitants of the region including the base before and after the change are similar to each other. Therefore, when the area type does not change before and after the change of the base, the control unit 23 may determine that the lifestyle of the user has not changed. On the other hand, when the area type changes before and after the change of the base, the characteristics of the residents of the region including the base before and after the change can be said to be different from each other. Therefore, when the area type changes before and after the change of the base, the control unit 23 determines that the first condition is satisfied, and can estimate that the lifestyle of the user has changed. In order to improve the estimation accuracy of the lifestyle change, the control unit 23 may acquire, for example, information indicating the age of the user stored in the user database.

Further, for example, the predetermined condition may be that a predetermined route search pattern is detected (hereinafter, also referred to as “second condition”). The predetermined route search pattern may be arbitrarily determined. For example, the predetermined route search pattern may be that the number of times of average route search during the first period (hereinafter, also referred to as “first average value”) has increased or decreased by a predetermined threshold value or more compared to the number of times of average route search during the second period before the first period (hereinafter, also referred to as “second average value”). The first period, the second period, and the predetermined threshold may be arbitrarily determined. The first average value and the second average value can be calculated, for example, by the control unit 23 analyzing the usage history of the action tendency information. For example, in a case where it is detected that the first average value has decreased by a predetermined threshold or more compared to the second average value in a certain first period, there is a possibility that some change has occurred in the life of the user. If the user is a company employee, the work form may be changed (e.g., switching from work to telecommuting). Therefore, when the second condition is satisfied, the control unit 23 may estimate that the rice style of the user has changed, and may decide to execute a second change process to be described later. In this example, a change in the user's rice style can be detected regardless of the registration information on the geographic application, which is useful when the user does not update the registration information such as “home” or “work” as in the second example described above.

Specifically, the control unit 23 may identify the route search pattern of the user by analyzing the action tendency information including the position information of the terminal device 10, the usage history of the geographic application, or both. For example, as a result of the analysis of the usage history by the control unit 23, it is estimated that there is a daily routine in which the user performs route search during the time of returning home on each company day. In this case, the first period may be set to 5 weekdays before the day before the operation execution day of FIG. 6, the second period may be set to 5 weekdays immediately before the first period, and the predetermined threshold may be set to 3. It is assumed that, in a certain first period, it is detected that the first average value has decreased by a predetermined threshold value (3 in this case) or more compared to the second average value. This may suggest that the workday of the user's weekday is decreasing due to the change in the working form. The greater the likelihood of such a decrease in the number of averaged path searches being detected in succession. Therefore, when a predetermined route search pattern is detected, the control unit 23 may determine that the second condition is satisfied, and may estimate that the lifestyle of the user has changed.

In this case, the position information of the terminal device 10 of the user may be acquired as the action tendency information, and may be accumulated as history data indicating the position history of the terminal device 10. In this example, the registration information on the route search application may not be changed. However, in practice, the place where the user frequently appears is changed from the work place to the home place. For this reason, in the case of a user who has shifted to full telecommuting, a place registered as a “work place” on the route search application may not be a place (i.e., a base) where the user frequently appears. In preparation for such a case, it is desirable that the action tendency information also include position information of the terminal device 10 of the user at early morning, during daytime, and at night (e.g., 6:00, 11:00, 16:00, and 21:00, for example) on weekdays. For example, if a typical time zone of work is set as a criterion, a location where a user frequently appears early in the morning and at night may be estimated as a home, and a location where a user frequently appears during the day may be estimated as a work place. As a result of analyzing the historical data by the control unit 23, when it is found that the frequency at which a place estimated as a work place and a place estimated as a home coincide with each other tends to increase on the basis of a certain day, this may suggest that the work form of the user is changed (e.g., switching from the work place to the telecommuting work). In this case, the control unit 23 may determine that the location (i.e., the base) at which the user frequently appears has been changed based on the history data (S101—Yes), determine that the change of the base of the user satisfies a predetermined condition (second condition) (S103—Yes), and estimate that the lifestyle of the user has changed.

S104: When the control unit 23 determines that the predetermined condition is satisfied (S103—Yes), the control unit 23 executes a second change process of changing an advertisement related to the lifestyle of the user.

The second change process can be executed in any manner. For example, a user who moves on the occasion of childbirth may have a strong interest in certain items (typically baby items). In addition, it is more likely that a person who has just moved from City A (downtown) to City B does not own certain commodities (typically family cars) than a person who has lived in City B (a residential district popular among family households) for many years. In addition, in the case of a user who has shifted to telecommuting, it is expected that interest in certain products (eating and drinking services, etc.) will change due to a change in a place where the frequency of appearance is high from the vicinity of the workplace to the vicinity of the home. As described above, the time when the predetermined condition is satisfied in the user whose base is changed can be said to be the time when the advertising appeal effect is high. Therefore, the control unit 23 can execute the second change processing by considering a case where a predetermined condition is satisfied (here, a change in home) as a change in lifestyle, and determining, for example, an advertisement of a certain product or the like without a presentation result, or an advertisement of an advertiser or a certain product or the like in which the provision place is changed as appropriate, as an advertisement to be presented to the user. As a result, it is easy to present an advertisement tailored to the lifestyle to the user without missing a time when the advertising appeal effect is high.

S105: The control unit 23 presents an advertisement determined by executing the first change process and/or the second change process to the user. After that, the process ends.

Specifically, the control unit 23 can present the advertisement to the user by causing the terminal device 10 of the user to transmit and output the advertisement determined by executing the first change process and/or the second change process via the communication unit 21 and the network 30.

After passing through S105 from S101, if it is determined that the base of the user has been changed based on the action tendency information, the control unit 23 may execute the first change processing and determine whether to execute the second change processing according to whether or not the change of the base satisfies a predetermined condition. When it is determined that the base of the user has been changed in S101 and the change of the base satisfies a predetermined condition, the control unit 23 estimates that the lifestyle of the user has changed, and executes the second change process in addition to the first change process. On the other hand, even when it is determined that the base of the user has been changed, when the change of the base does not satisfy the predetermined condition, the control unit 23 estimates that the lifestyle of the user has not changed, and does not execute the second change process.

As described above, the information processing device 20 according to the present embodiment acquires information indicating the action tendency of the user from the terminal device 10 of the user. On the basis of the information, when it is determined that the base of the user has been changed, the information processing device 20 executes a first change process of changing the advertisement due to the geographical change of the base, and determines whether to execute a second change process of changing the advertisement related to the lifestyle of the user according to whether or not the change of the base satisfies a predetermined condition.

According to such a configuration, for example, when a change in the base is detected, the advertisement is changed due to the geographical change of the base, but if the change in the lifestyle is not detected even if the base is changed, the advertisement related to the lifestyle cannot be changed. Therefore, the technology related to the targeting advertisement is improved in that it is easy to present an advertisement tailored to the lifestyle of the user while easily detecting a change in the base of the user and specifying a timing at which the advertising appeal effect is high.

Although the present disclosure has been described above based on the drawings and the embodiments, it should be noted that those skilled in the art may make various modifications and alterations thereto based on the present disclosure. It should be noted, therefore, that these modifications and alterations are within the scope of the present disclosure. For example, the functions included in the configurations, steps, etc. can be rearranged so as not to be logically inconsistent, and a plurality of configurations, steps, etc. can be combined into one or divided.

For example, as a first modification of the above-described embodiment, the control unit 23 may estimate an activity time zone of the user from the action tendency information and adjust a timing at which the determined advertisement is presented to the user. In this case, in order to estimate the activity time zone of the user, the action tendency information may include information indicating the purchase history or the use result of the traffic ticket as the usage history of the route search application. This allows for more timely presentation of advertisements to the user. The term “timely” as used herein refers not to immediate distribution in which the user's position information is constantly monitored and an advertisement is presented immediately after entering the store, but to presenting an advertisement “at a timing suitable for the user's activity time zone” to the user. In other words, in the immediate distribution of the advertisement, there is a possibility that the monitored feeling is strong and the user feels uncomfortable, and it may be difficult to enhance the appealing effect of the advertisement. On the other hand, in the present embodiment, by capturing the change in the lifestyle of the user by using the action tendency information, it is easy to present the advertisement at an appropriate timing without giving discomfort to the user. For example, it is assumed that the control unit 23 analyzes the purchase history and the use result of the traffic ticket, and thus it is found that the activity time zone of the user is in the daytime sandwiching the lunch time zone. In this case, the departure point and the destination of the user (here, the boarding station of the passenger vehicle) and the arrival and departure time of the passenger vehicle may be specified from the route search result, and an advertisement of a restaurant around the destination (getting-off station) may be presented to the user of the terminal device 10 in the lunch time zone.

Further, for example, as the second modification of the above-described embodiment, the geographic application may be an application program (hereinafter, also referred to as a “map application”) that displays map information. In this case, for example, the user may select a starting point and a destination spot on the map of the map application, perform route search, and browse route search results. Information such as the departure point and destination selected by the user and the route search results viewed may be stored in the user database as a usage history.

Further, for example, in the above-described embodiment, the configuration and operation of the information processing device 20 may be distributed among a plurality of computers capable of communicating with each other. For example, the information processing device 20 according to the above-described embodiment may be distributed to a first server managed by an operator of a geographic application and a second server managed by an advertiser. Further, for example, an embodiment in which some or all of the components of the information processing device 20 are provided in the terminal device 10 is also possible.

Further, an embodiment is also possible in which, for example, a general-purpose computer functions as the information processing device 20 according to the above embodiment. Specifically, a program describing processing contents for realizing each function of the information processing device 20 according to the above embodiment is stored in the memory of the general-purpose computer, and the program is read out and executed by the processor. Therefore, the present disclosure can also be realized as a program that can be executed by the processor or a non-transitory computer-readable medium that stores the program.

What is claimed is:

1. An information processing device provided with a control unit, wherein the control unit
acquires information indicating an action tendency of a user from a terminal device of the user, and
executes a first change process of changing an advertisement due to a geographical change of a base of the user when a change of the base is determined to be made, and determines whether to execute a second change process of changing an advertisement related to a lifestyle of the user in accordance with whether the change of the base satisfies a predetermined condition, based on the information.

2. The information processing device according to claim 1, wherein:
the predetermined condition is that a base where a change is detected is home of the user and an area type indicating characteristic of an area of the home before and after the change is changed; and
when the predetermined condition is satisfied, the control unit estimates that the lifestyle of the user is changed and executes the second change process.

3. The information processing device according to claim 1, wherein:
the predetermined condition is that a predetermined route search pattern is detected; and
when the predetermined condition is satisfied, the control unit estimates that the lifestyle of the user is changed and executes the second change process.

4. The information processing device according to claim 1, wherein the information includes position information of the terminal device, a usage history of an application program into which geographical information is input, or both of the position information and the usage history.

5. The information processing device according to claim 4, wherein:
the application program into which the geographical information is input is an application program used for route search; and
the information includes registration information of a station to be used, a route search result, or both of the registration information and the route search result.
